(19) United States
(12) Patent Application Publication
(10) Pub. No.: US 2003/0043761 A1
(43) Pub. Date: Mar. 6, 2003

(54) Channel structures and protocol for asset tracking satellite communications links

(76) Inventor: Stephen Michael Hladik, Albany, NY (US)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(21) Appl. No.: 10/264,804

(22) Filed: Oct. 4, 2002

Related U.S. Application Data
(63) Continuation of application No. 09/210,825, filed on Dec. 14, 1998.

(51) Int. Cl. H04B 7/204

(52) U.S. Cl. 370/319; 370/321

(57) ABSTRACT

A hybrid FDMA/TDMA technique with both scheduled and random access slots in the return link (tracking unit to hub) and scheduled, broadcast, and acknowledgment slots in the forward link (hub-to-tracking unit) and the associated protocol enables the use of low-energy modem signal processing, while providing advantageous features such as polling, expedited exception event reporting, terrestrial wireless local area network support, tracking unit login/logout, and beam-to-beam hand-off.

### BACKGROUND OF THE INVENTION

1. Field of the Invention

This invention relates to satellite communications protocols and, more particularly, to a multiple access technique and a two-way protocol for communications via satellite in the tracking of assets, including goods and vehicles.

2. Description of the Prior Art

U.S. Pat. No. 5,588,005 to Ali et al., issued Dec. 24, 1996 and assigned to the instant assignee, describes the tracking of assets, including goods and vehicles, using the Global Positioning System (GPS). While goods are an example of assets that need to be tracked, the containers, container trucks and railcars in which the goods are shipped are themselves assets which need to be tracked, not just because of the goods they carry, but also because they represent capital assets typically of a leasing company not associated with the carrier.

The mobile tracking unit used in the Ali et al. system includes a navigation set, such as a Global Positioning System (GPS) receiver or other suitable navigation set, responsive to navigation signals transmitted by a set of navigation stations which can be either space-based or earth-based. In each case, the navigation set is capable of providing data indicative of the vehicle location based on the navigation signals. In addition, the mobile tracking unit can include a suitable electromagnetic emitter for transmitting to a remote location the vehicle's position data and other data acquired with sensing elements in the vehicle.

There are two modes of communication for the asset tracking units. The first of these modes is that in which the communication is carried out between a central manager or station and the individual tracking units. This communication usually takes place through a satellite link. The second mode is the local area network, referred to as the “mutter” mode, in which a subset of tracking units communicate with each other in a mobile dynamically configured local area network (LAN).

The first of these modes is the primary communication link for tracking the assets. Mutter mode communication is used as the secondary communication mechanism to conserve power. Ali et al. specify a protocol for mutter mode communication in their patent. The prime requirement of any protocol is that it be simple for implementation purposes and at the same time be robust under different failure modes. The protocol developed for the mutter mode makes use of the fact that there exists a two-way communication channel between the tracking units and the central station. Since the central station has use of a fairly powerful computer, the central station's processing power is used in setting up and maintaining the mutter mode network. This enables keeping the mutter mode protocol simple and reduces the complexity at individual tracking units whose numbers may be in the hundreds of thousands. In conjunction with the protocol for the central station communication, the protocol for mutter mode communication is very similar. The frame structure developed for the central station communication protocol can be used for the mutter mode communication as well. This further simplifies the implementation of the mutter mode communication.

Further improvement can be made to the Ali et al. system. In particular, a multiple access technique and a two-way protocol for communications via satellite are needed for low-energy consumption asset tracking units that report location and sensor data to a hub terminal and respond to commands from the hub.

The Inmarsat-C satellite communication system offers a variety of message and data transfer services. This system uses Frequency Division Multiple Access/Time Division Multiplex (FDMA/TDM) forward channels and Frequency Division Multiple Access/Time Division Multiple Access (FDMA/TDMA) return channels. While the system protocol utilizes both random and assigned access methods in the return links, its channel structures and protocol require that the mobile terminal's receiver operate for relatively long periods of time compared to the asset tracking communication system described herein. This difference is significant because it has been determined that the satellite communications receiver is a major consumer of energy in typical telemetry equipment.

### SUMMARY OF THE INVENTION

It would therefore be desirable to provide a multiple access technique and a two-way protocol for communications via satellite for low-energy consumption asset tracking units that report location and sensor data to a hub terminal and respond to commands from the hub.

In a preferred embodiment of this invention, a hybrid FDMA/TDMA technique with both scheduled and random access slots in the return link (inbound carrier signal, tracking unit to hub) and scheduled, broadcast, and acknowledgment slots in the forward link (outbound carrier signal, hub-to-tracking unit) and the associated protocol enables use of low-energy modem signal processing, while providing advantageous features such as polling, expedited exception event reporting, terrestrial wireless local area network support, tracking unit login/logout, and beam-to-beam hand-off.

The channel structure and protocol described herein is different from Inmarsat-C in that it reduces the required receiver operation time. This is achieved by using a forward channel structure having predictable, periodic communications with the tracking units, frequent synchronization bursts (in the broadcast slots), and short messages. Inmarsat-C interleaves several messages in an 8.64 second frame. This requires that the mobile terminal demodulate an entire frame in order to extract a received message. Secondly, the protocol documented here makes more use of regularly scheduled channel access. This has two benefits: (1 ) effective power management (turning off circuits that are not in use) can be employed in the radio to conserve energy; and (2) the number of retransmissions due random access collisions is greatly reduced.

While Inmarsat-C has an optional pre-assigned (scheduled) data transmission mode, the protocol requires the mobile terminal to partition return-link messages into 11-byte blocks. It is necessary to receive a forward channel frame before transmitting each 11-byte block in order to receive a message acknowledgment for previous block and to verify that the channel has been reserved for transmission of the next block of data. The communication system described herein allows an entire standard tracking unit message to be transmitted in a single time slot.

### BRIEF DESCRIPTION OF THE DRAWINGS

FIG. 1 is a block diagram of an exemplary asset tracking system which employs mobile tracking units;

FIG. 2 is a block diagram showing in further detail a mobile tracking unit as used in the tracking system shown in FIG. 1;

FIG. 3 is a block diagram illustrating the organization of the mobile local area network implemented in the tracking system shown in FIG. 1;

FIG. 4 is a frame structure diagram showing a satellite communications return link frame according to a preferred embodiment of the invention;

FIG. 5 is a frame structure diagram showing a satellite communications forward link frame according to a preferred embodiment of the invention; and

FIG. 6 (comprising FIGS. 6A and 6B) is a flow diagram of a TDMA system protocol for tracking unit login in the practice of the present invention.

### DETAILED DESCRIPTION OF A PREFERRED EMBODIMENT OF THE INVENTION

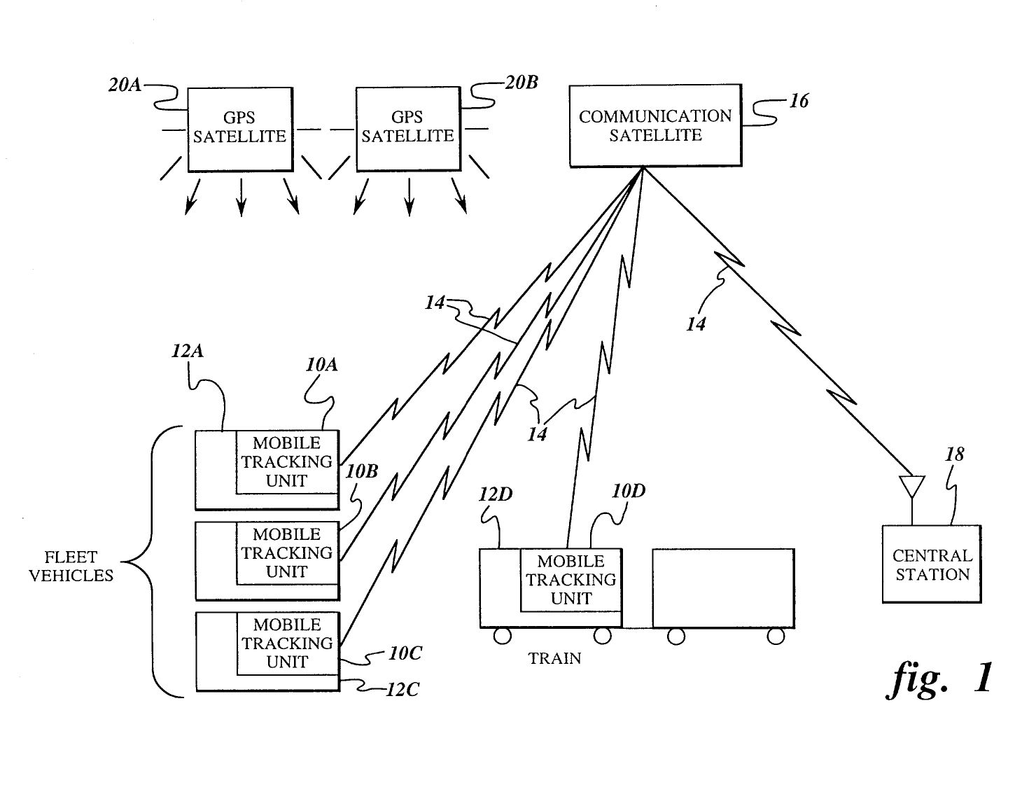

FIG. 1 illustrates, by way of example and not of limitation, mobile tracking units which employ navigation signals from a GPS satellite constellation, although, as suggested above, other navigation systems can be used in lieu of GPS. FIG. 1 shows a set of mobile tracking units 10A-10D which are installed in respective vehicles 12A-12D to be tracked or monitored. A communication link 14, such as a satellite communication link using a communication satellite 16, can be provided between each mobile tracking unit (hereinafter collectively designated as 10) and a remote control station 18 manned by one or more operators and having suitable display devices and the like for displaying location and status information for each vehicle equipped with a respective mobile tracking unit. Communication link 14 can be conveniently used for transmitting vehicle conditions or events measured with suitable sensing elements. Communication link 14 is a two-way link allowing the network control terminal to transmit messages and commands to the tracking units to further enhance reliability and functionality of the asset tracking system. A constellation of at least three Global Positioning System (GPS) satellites, such as GPS satellites 20A and 20B, provides highly accurate navigation signals which can be used to determine vehicle position and velocity when acquired by a suitable GPS receiver.

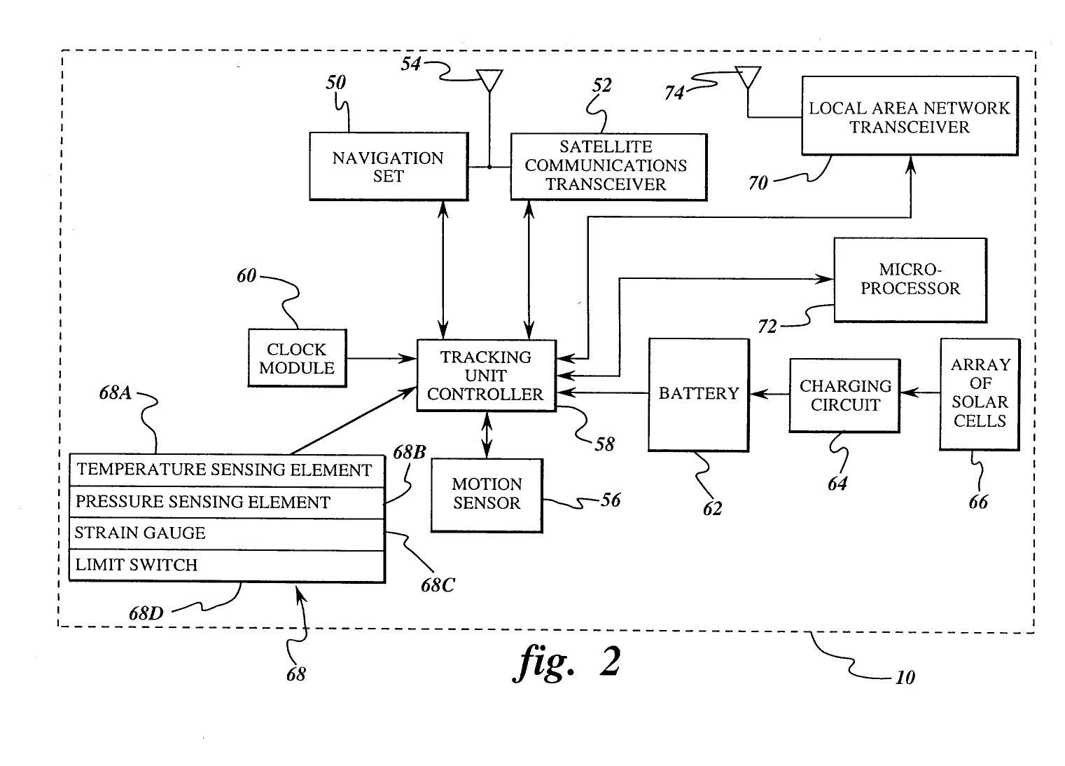

FIG. 2 shows a mobile tracking unit 10 which includes a navigation set 50 capable of generating data substantially corresponding to the vehicle position. The navigation set is chosen depending on the particular navigation system used for supplying navigation signals to a given mobile tracking unit. Preferably, the navigation set is a multiple-channel GPS receiver. However, other receivers designed for acquiring signals from a corresponding navigation system may alternatively be employed. Mobile tracking unit 10 also includes a suitable transceiver 52 functionally independent from navigation set 50. A key advantage of the present invention is the ability to substantially reduce overall power consumption of the mobile tracking unit by selectively reducing the activation time of satellite communications transceiver 52 and other components of the mobile tracking unit. Both communications transceiver 52 and navigation set 50 are actuated by a controller 58, which receives clock signals from a clock module 60. Transceiver 52 is capable of transmitting the vehicle position data by way of communication link 14 (FIG. 1) to the control station and receiving commands from the control station by way of the same link. If a GPS receiver is used, the GPS receiver and the communications transceiver can be conveniently integrated as a single integrated unit for maximizing efficiency of installation and operation. A single, low profile antenna 54 can be conveniently used for both GPS signal acquisition and satellite communication if L-band frequencies are also used for satellite communication.

The invention may also employ a low power, short distance radio link between multiple location/tracking units to reduce power and increase reliability and functionality of the tracking system. In addition to a power source which comprises a battery pack that can be charged by an array of solar cells 66 through a charging circuit 64, a GPS receiver, a communications transmitter, a microprocessor 72, and various system and vehicle sensors 68A-68D as shown in FIG. 2, each tracking unit may also include a low power local area network (LAN) transceiver 70. A microprocessor 72 is interfaced to all of the other elements of the tracking unit and has control over them. The LAN signals are broadcast over antenna 74.

One purpose of this invention is to reduce power consumption required for communication between an asset tracking unit and central station via satellite.

Described below are forward link FDMA/TDM and return link FDMA/TDMA channel structures of the satellite communications links, along with the functions of the features of those channel structures. In general, the combined frequency and time division approach to multiple access for this application is advantageous because the satellite communications link is easily expandable in modest bandwidth resource increments as the number of tracking units increases. In a preferred embodiment, a single 5 kHz channel on a geostationary satellite can support approximately 10,000 tracking units, which report once per hour. Furthermore, all control signaling is multiplexed on a time division basis with position and sensor information. Therefore, a single 5 kHz channel is all that is required to support up to 10,000 tracking units; a separate control channel frequency is not required. Additional tracking units can be supported by simply utilizing more satellite bandwidth. It is preferable, from the standpoint of protocol simplicity, to operate this satellite communications (SATCOM) link in a contiguous frequency band, but it is not necessary.

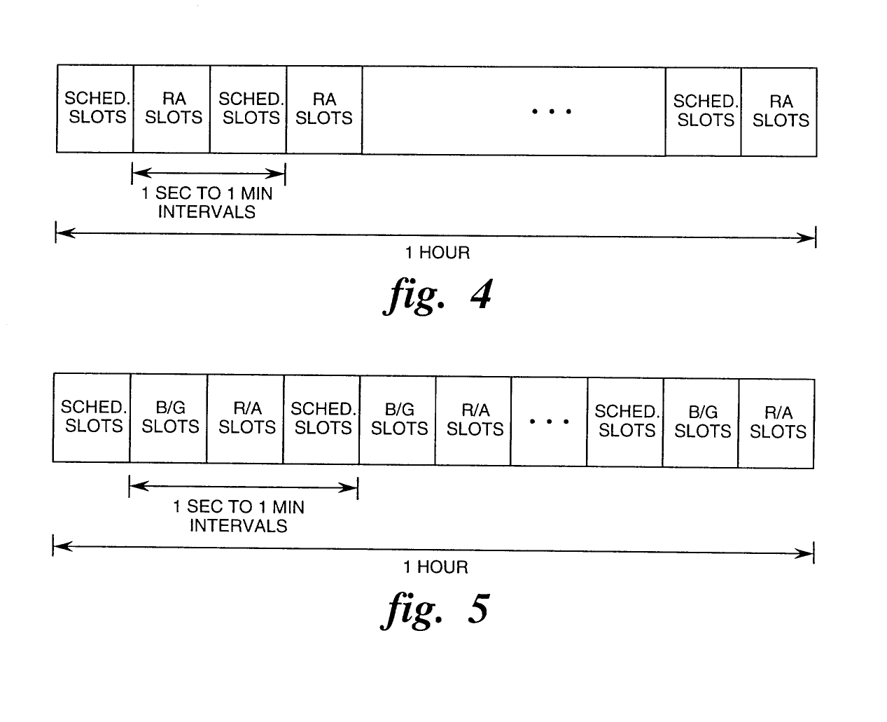

The frame structure of the FDMA/TDMA return link is shown in FIG. 4 to comprise scheduled time slots (SCHED. SLOTS) that are assigned to the tracking units by the network control terminal and random access (RA) time slots. The slots assigned to a particular tracking unit occur periodically at least once per hour, and are used by the tracking units to report position and sensor to information. These assignments remain fixed until an event occurs that necessitates a change in the return channel resource allocation. Examples of such events include tracking unit logout/power down and inter-beam hand-off.

The return channel random access (RA) slots are used by the tracking units to log into the asset tracking SATCOM network, report high priority sensor messages in a timely fashion, respond to unscheduled report requests, respond to commands that are issued at times other than the assigned forward channel slot, and facilitate beam-to-beam hand-offs if the satellite transmits on different frequency bands in multiple beams which together cover a geographic area. The interval between RA slots is typically between one second and one minute. The random access slots also occur periodically in the return link frame structure.

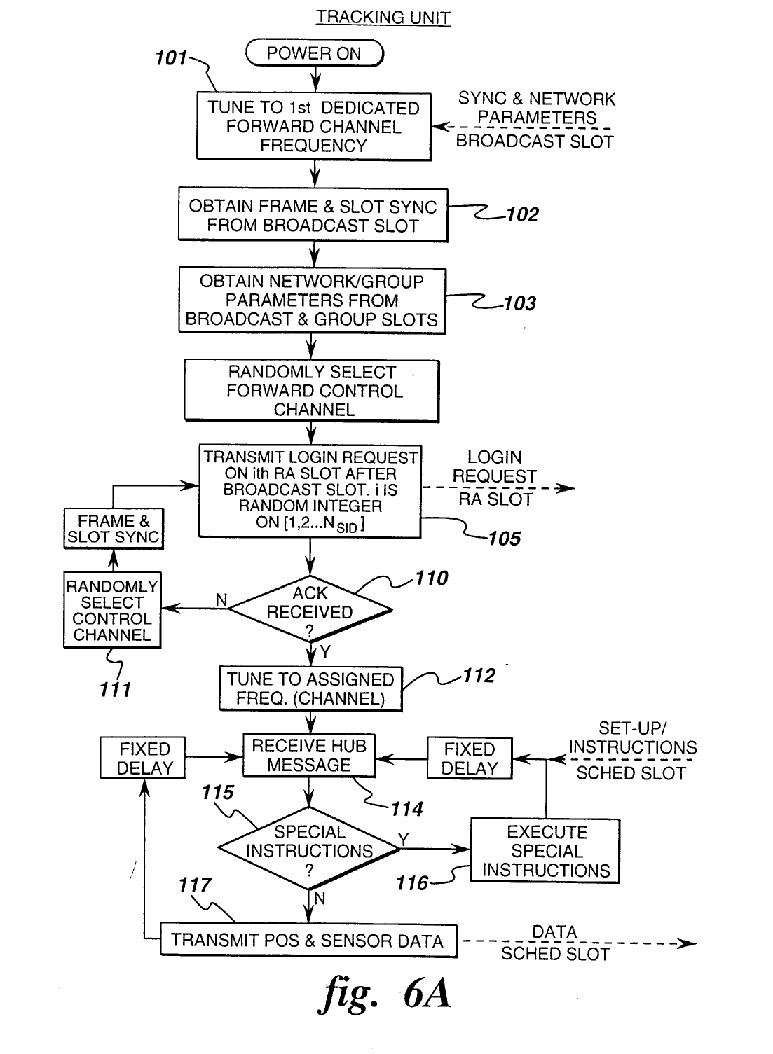

The frame structure for an FDMA/TDM forward link is shown in FIG. 5 to comprise scheduled time slots (SCHED. SLOTS), broadcast/group (B/G) message slots, and response/acknowledge (R/A) slots. The forward channel scheduled time slots are paired with the scheduled slots in the return link to provide two-way communication between each tracking unit and the network control terminal on a regularly scheduled basis (at least once per hour).

All tracking units will wake periodically to monitor the brief broadcast or group messages in the broadcast/group (B/G) time slots. The B/G slots broadcast network parameters and protocol information, and facilitate tracking unit log-in, network synchronization, and inter-beam hand-offs. The B/G slots are also used by the network control terminal to poll tracking units for unscheduled reports and to issue network control commands on an unscheduled basis. The network control terminal can also direct command messages to a specific group of assets using the B/G slots.

The response/acknowledge (R/A) slots are paired with the return-link random access (RA) time slots and are used to transmit responses or acknowledgments to return channel RA slot messages. When a tracking unit transmits a message on a return channel RA slot, the tracking unit listens for a response or acknowledgment on the predetermined forward channel R/A slot.

In each R/A time slot, the network control terminal transmits one of the following messages:

i. directed acknowledgment—an acknowledgment directed to an individual tracking unit by using its identification number; and

ii. no message received—an indication to all tracking units that no message was received successfully in the associated return channel RA slot by utilizing the broadcast address.

A direct acknowledgment may be accompanied by control commands. If a no-message received indication is received in the R/A slot, each tracking unit that transmitted during the associated return channel RA slot assumes that a collision has occurred and waits a random number of RA slots before repeating its message.

The number of B/G slots and the interval between them are selected based on traffic estimates and communications requirements. Likewise, the interval between R/A time slots is chosen based on these same considerations, while the delay between a return channel R/A slot and the associated forward channel R/A slot is primarily chosen based on message processing requirements and is generally made as small as is feasible. These estimates of random access traffic determine the amount of SATCOM network resource that is required for B/G and R/A slots.

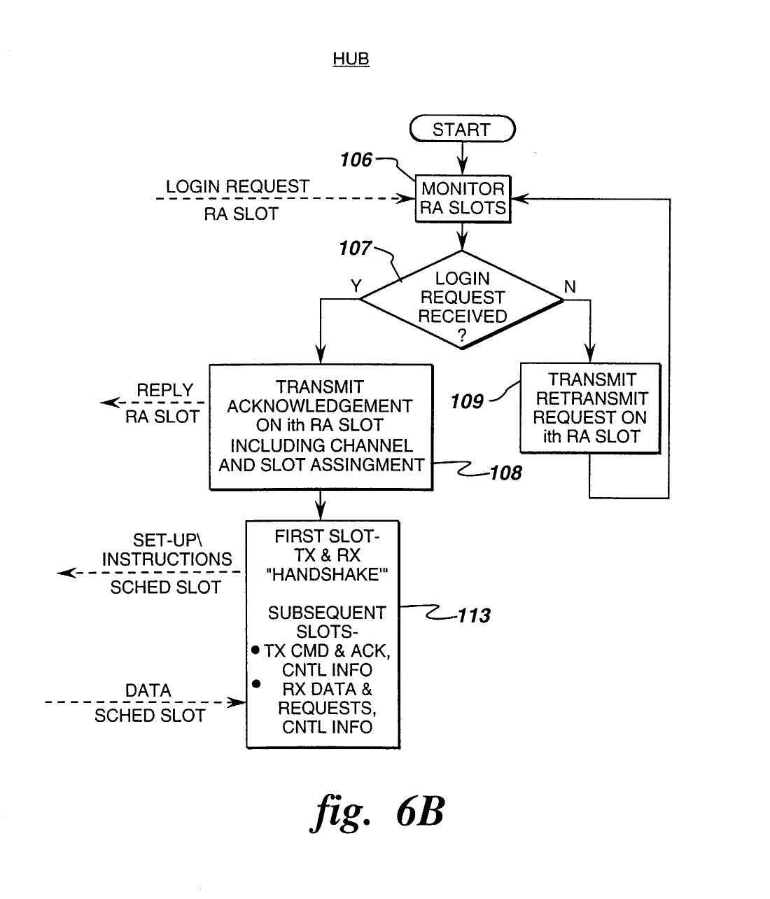

FIG. 6 is a flow diagram that illustrates how the protocol and channel structure for the FDMA/TDMA satellite communications link support tracking unit login to the satellite communication system.

The tracking unit, upon power-up, first registers with the network. The registration procedure is as follows. The tracking unit tunes to the first dedicated forward channel frequency at step 101. The tracking unit obtains frame and slot synchronization from a broadcast slot on the forward channel at step 102. The tracking unit reads the network parameters from this broadcast slot at step 103. If it is a member of a network group, the tracking unit obtains any parameters or instructions for that group. If the network parameter message indicates that more than one forward channel is available, the tracking unit selects one forward channel at random unless the broadcast or group message indicates otherwise, at step 104. At step 105, the tracking unit selects a slot index delay at random from the integer set {1,2, . . . , N_{sid}}, where the parameter N_{sid} is a design parameter. This slot index delay represents the relative index of the random access slot on the return channel following the first found forward channel broadcast slot that is to be used to transmit a login request. That is, if the tracking unit selects the number i from the set {1,2, . . . , N_{sid}}, the tracking unit skips i−1 random access slots on the return channel and transmits on the i^{th} random access slot.

The hub continuously monitors RA slots, as indicated at step 106. If the hub receives the login request, as determined at step 107, the hub replies to the tracking unit with a channel (forward/return frequency pair) and slot assignments at step 108. This reply is transmitted on the forward channel response/acknowledge (R/A) slot that corresponds to the random access (RA) slot received by the hub on the return link. If the login request of the tracking unit collides with the message of another tracking unit on a return channel RA slot, or is corrupted by the channel, the hub indicates that no message has been received on that particular random access slot. The broadcast-mode address is used at step 109 so that any tracking units that may have tried to transmit a message in that RA slot will be notified that its message was not received.

Meanwhile, at the tracking unit, if the reply from the hub cannot be interpreted, it is assumed, at step 110, that receipt of the message from the tracking unit has not been acknowledged. In the event of an unsuccessful transmission attempt, the tracking unit waits, at step 111, during a randomly selected number of return channel RA slots before attempting, at step 105, to retransmit its login request. Once channel and slot assignments have been received by the tracking unit, it tunes to the designated forward channel carrier frequency at step 112 after the delay indicated by the assigned slot.

A “handshake” is then executed between hub and tracking unit using in-band signaling on the traffic slots. To perform this “handshake”, the hub first transmits a command on the assigned forward channel traffic slot at step 113. The hub message is received and decoded at step 114. A determination is made at step 115 as to whether there are special instructions in the decoded message. If so, the special instructions are executed at step 116 and, after a fixed delay, the process loops back to step 114. The special instructions executed may include the tracking unit replying on the assigned return channel traffic slot at step 117 to complete the “handshake”. Two-way communication between the hub and tracking unit is conducted over the assigned channel slots periodically (e.g., once per hour) thereafter.

Network synchronization is facilitated by preambles contained in the forward channel broadcast slots, which are transmitted periodically by the hub. Upon power-up, tracking units monitor the lo first dedicated forward channel and synchronize to the broadcast slot preambles. Tracking units that have registered with the network maintain synchronism with the network by periodically exiting the energy conservation mode or “waking” to monitor the forward channel broadcast slots.

For a tracking unit that has logged into the SATCOM network, the assigned forward channel time slot used by the network control terminal to transmit to that tracking unit provides an additional reference that can be used to maintain network synchronization.

If a report from a given tracking unit is desired at a time other than the assigned time slot, the hub sends a command addressed to that tracking unit during the nearest available forward channel broadcast slot. The tracking unit transmits the requested report on a return channel R/A slot. The hub can provide the tracking unit with an assigned slot for its reply by designating a particular return channel random access slot in its command message. This approach necessitates a broadcast announcement to reserve that specific return channel RA slot in advance. A second alternative is to reserve some slots in the return channel specifically for the transmission of unscheduled reports.

The slot structures of the forward and return links include overhead bits dedicated to control signaling. These overhead bits are referred to as the slow associated control channel (SACCH). The SACCH can be used to communicate control messages, special report requests, and terrestrial wireless local area network control information. In particular, in-band signaling may be useful in the organization and maintenance of terrestrial wireless local area networks.

Transmission of longer control messages can be handled in two ways. First, a high priority, longer control message can be transmitted in lieu of the regularly scheduled position information. The use of an entire traffic slot for control messages is known as a fast associated control channel (FACCH). Second, a longer control message can be assigned via the SACCH to a specific random access slot. Using the latter technique, it is not necessary to sacrifice a position/status message in order to transmit a longer control message.

Some control functions may require the exchange of several messages in each direction in a short period of time (on the order of minutes rather than hours). For such an exchange between the tracking units and hub terminal, the use of the SACCH or FACCH is not adequate, if the system is designed to provide one slot per tracking unit per hour, as in one embodiment of the invention. This more rapid exchange of control messages is supported by the proposed protocol and frame structure through use of the random access slots (possibly on a reservation and assignment basis).

The network control terminal can broadcast messages to all tracking units in the network via the forward link broadcast slots. This feature of the forward frame structure allows the network control terminal to broadcast network parameters, protocol information and control commands to all tracking units simultaneously. Because the schedule of the broadcast slots is known, the tracking units conserve power by going into a power conservation or “sleep” mode in which unused circuits are turned off and only waking periodically to monitor broadcast messages.

In a manner akin to the broadcast to all tracking units in the network, the network control terminal can transmit messages to all tracking units in a specified tracking unit group via the forward link broadcast/group message slots. This feature of the forward frame structure allows the network control terminal to broadcast control commands to all tracking units in a group simultaneously. Examples of groups of interest might be: all vehicles of a particular type, all vehicles leased or owned by the same company, all vehicles in a defined area, all vehicles headed for the same destination, all vehicles having a common point of departure, all vehicles carrying the same cargo, and all vehicles on a similar maintenance schedule.

Possibilities for location-based addressing include assets in regions defined by:

i. center coordinates and a specified range;

ii. latitude and longitude boundaries; and

iii. current contact with a specified terrestrial wireless LAN master tracking unit. (This implies a maximum range from the master's position.)

The random access slots in the return link frame provide the capability to support more timely reporting of high priority events than is possible using only regularly scheduled tracking unit time slots. An important parameter of the frame structure which can be optimized for a particular application is the rate of the random access time slots. The time interval between RA slots will be based on the anticipated frequency of high priority events and the number of tracking units per frame. Naturally, the number of random access slots per return channel frame affects the required channel signaling rate for a fixed number of tracking unit slots per frame and, therefore, the required transmitted effective isotropically radiated power (EIRP).

The following table illustrates the tradeoff between the number of RA slots per frame and the required increase in transmitted EIRP relative to a return link frame without RA slots for one embodiment of the invention. These data are based on 10,000 tracking units accessing the return link using TDMA. In this embodiment, each tracking unit transmits 1000 bits/hr, and there is a 12 msec guard time between slots.

| RA Slot | | # RA | | Increase in EIRP |
|---|---|---|---|---|
| Interval | | Slots/hr | Signaling Rate | (dB) |
| 5 | min | 12 | 2.877 kbps | 0.005 |
| 1 | min | 60 | 2.891 kbps | 0.027 |
| 20 | sec | 180 | 2.927 kbps | 0.080 |
| 10 | sec | 360 | 2.981 kbps | 0.159 |
| 5 | sec | 720 | 3.088 kbps | 0.313 |
| 2.5 | sec | 1440 | 3.304 kbps | 0.606 |
| 1.25 | sec | 2880 | 3.738 kbps | 1.143 |
| 0.625 | sec | 5760 | 4.621 kbps | 2.063 |

A second alternative is to fix the number of slots per frame per channel and to use more satellite bandwidth. In this case, the cost is the increased operating cost of the network due to the increased bandwidth leased or purchased, rather than increased tracking unit EIRP.

The following table presents the estimated maximum message throughput of the random access time slots in a single channel, expressed as a percentage of the number of tracking units per frame. The same TDMA channel structure parameters as above apply. The data of the last column mean that the random access slots can support the given percentage of tracking units that are active per hour for high priority reporting. The message throughput values given represent 68% and 45%, respectively, of the theoretical message throughput for slotted-ALOHA with Poisson message generation statistics. Slotted-ALOHA is well known in the art, and is described in B. Sklar, Digital Communications Fundamentals and Applications, Prentice Hall, 1988, pp. 500-502.

| | | | | *Max % of Tracking Units | |
|---|---|---|---|---|---|
| | | | | Covered Per Channel for | |
| | | | | High Priority Reporting | |
| | | | Max # Tracking | % of Max Slotted ALOHA | |
| RA Slot | | # RA | Units/(#RA | Throughput Assumed | |
| Interval | | Slots/hr | Slots/Channel) | 68% | 45% |
| 5 | min | 12 | 833 | 0.03 | 0.02 |
| 1 | min | 60 | 167 | 0.15 | 0.1 |
| 20 | sec | 180 | 56 | 0.45 | 0.3 |
| 10 | sec | 360 | 28 | 0.9 | 0.6 |
| 5 | sec | 720 | 14 | 1.8 | 1.2 |
| 2.5 | sec | 1440 | 7 | 3.6 | 2.4 |
| 1.25 | sec | 2880 | 4 | 7.2 | 4.8 |
| 0.625 | sec | 5760 | 2 | 14.4 | 9.6 |

*Assumes that maximum message throughput of slotted-ALOHA protocol is 1/4 and 1/6 of the number of available random access slots, respectively. (The theoretical maximum message throughput of slotted-ALOHA is 1/e 0.368 when all tracking units generate messages randomly according to a Poisson distribution.)

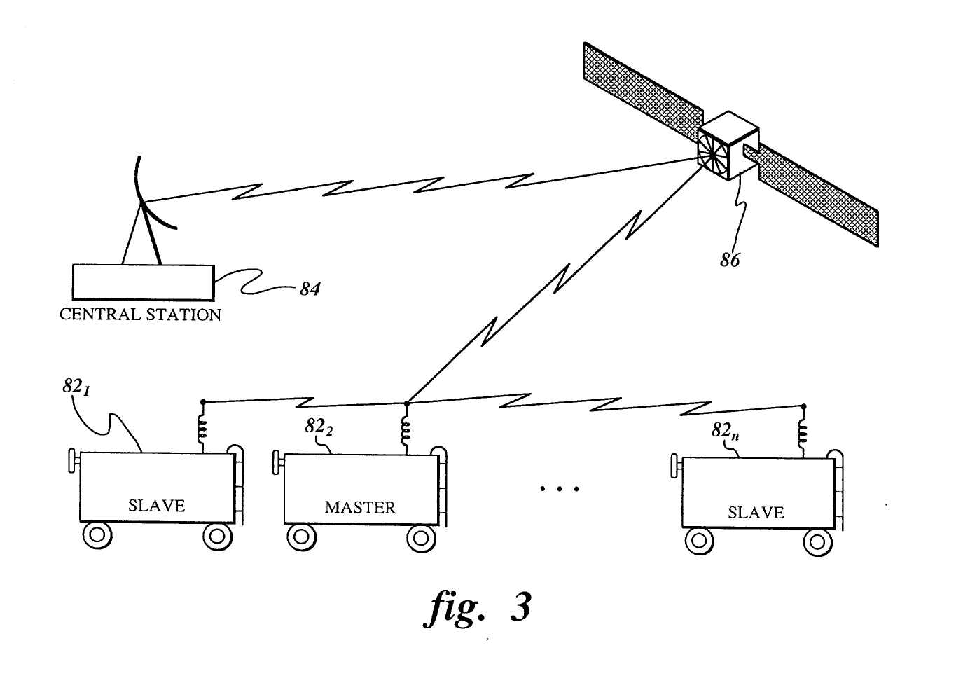

The fixed frame structure of the FDMA/TDMA return SATCOM link provides an easy-to-access resource on which the master tracking unit of a terrestrial wireless local area network LAN can transmit position/status reports on behalf of other subordinate tracking units in that LAN. This is illustrated in FIG. 3 wherein the LAN comprises tracking units 82₁-82ₙ, with tracking unit 82₂ acting as the master and the other tracking units in the LAN acting as slaves. The master unit is linked to a network control terminal at a central station 84 through a satellite relay 86.

There are two possibilities. The first retains the full position resolution and sensor reporting that is possible via direct tracking unit-to-NCT (network control terminal) SATCOM transmissions. In this approach, the LAN master tracking unit simply relays the desired information from the subordinate tracking unit in the scheduled time slot for that tracking unit.

The second approach allows greater energy savings for both the LAN master tracking unit and subordinate tracking units. In this approach, the LAN master tracking unit transmits its position and status information in its scheduled return link slot, using the scheduled slots of the subordinate tracking units in its LAN to report only on LAN membership status and the occurrence of high-priority events. The subordinate tracking units save energy in this mode because they shut off their GPS receivers. The network control terminal knows that the tracking units listed as still in the LAN by the master tracking unit are within a certain range of the master. The master tracking unit saves energy by transmitting fewer bits, since, generally, only subordinate tracking unit identification numbers are sent to the NCT. Occasionally, the master tracking unit may also have to report high priority sensor information on behalf of a subordinate tracking unit.

The protocol and channel structure for the FDMA/TDM forward and FDMA/TDMA return link system supports the formation, maintenance, and dynamic rearrangement of terrestrial wireless local area networks.

Since the SATCOM system for asset tracking has both forward and return links, the network control terminal (or hub) can direct the formation of terrestrial wireless LANs based on position and status information received from the tracking units on the scheduled reporting slots of the return links. The following steps summarize terrestrial wireless LAN formation.

i. The network control terminal (NCT) notifies a tracking unit via a forward channel transmission that it is to act as the master tracking unit for a terrestrial wireless LAN. The regularly scheduled forward link time slot or a broadcast slot can be used for this purpose.

ii. The appointed master tracking unit acknowledges receipt of this command on its scheduled time slot or an assigned random access slot in the return link frame.

iii. The network control terminal notifies the appointed LAN master tracking unit of identification numbers of prospective network member tracking units and, likewise, notifies the prospective local area network members of the identification number of the appointed LAN master tracking unit. Again, these messages are transmitted in the scheduled forward channel slot, broadcast/group (B/G) slots, or assigned reply/acknowledge (R/A) slots.

iv. The LAN network master and subordinate communicate via the terrestrial wireless LAN protocol to assimilate the subordinate into the LAN. The LAN master tracking unit reports the outcome of the subordinate entry attempt to the network control terminal via a return link RA slot.

v. If unsuccessful, the network control terminal may attempt to assign the prospective LAN subordinate tracking unit to another nearby master tracking unit of a different LAN. Another possibility is to retry the assimilation of the prospective subordinate into the LAN after an appropriate period of time in case of a change in signal blockage conditions.

Terrestrial wireless LAN maintenance and dynamic rearrangement are accomplished by routing commands from the network control terminal through the LAN master units to the subordinate tracking units. The NCT transmits to a LAN master tracking unit on its scheduled forward link time slot or those of the LAN subordinate members.

It is possible that a subordinate tracking unit will lose contact with its assigned LAN due to the relative movement of assets. When this occurs, the LAN master tracking unit omits that subordinate's identification number from the LAN member list sent to the NCT. Also, the LAN master tracking unit ceases to use that tracking unit's return SATCOM link time slot so that the “disconnected” subordinate tracking unit can use it to transmit to the network control terminal directly. A tracking unit that becomes separated from its assigned terrestrial wireless LAN can continue to communicate with the hub via its scheduled SATCOM link forward and return slots until the network controller assigns it to new LAN. To avoid confusion regarding identity of the actual transmitting unit, one of the overhead bits of the return link slots is used to indicate whether the information in that slot was transmitted by the unit corresponding to the identification number attached to the position and status data or by the assigned LAN master unit for that tracking unit.

The frequency plan for a multiple-beam satellite assigns a sub-band of its total frequency allocation to each beam in the system. The plan may also utilize limited frequency reuse by assigning the same set of channels to geographically separated beams.

The frequency plan of the satellite used by the system has significant effect on the design parameters chosen for the SATCOM link channel structure, slot structure, and protocol, because beam-to-beam hand-off may be necessary in order to track moving assets when using a multiple-beam satellite. When an asset is moving, it may begin to leave the coverage area of the satellite signal or beam providing the SATCOM link and enter a region in which two or more satellite beams overlap. This situation requires that the asset tracking unit be “handed-off” to a beam that can continue to provide coverage.

The support of inter-beam hand-off may require capability to exchange several control messages more rapidly than is possible via in-band signaling alone. The forward link B/G and R/A slots and the return link RA slots could be used for this purpose. Unlike cellular radio telephone, the hub has information that it can use to make hand-off assignments. This information includes: (1) accurate position data at least at hourly intervals, (2) a map of the highway or rail system vehicle routes, (3) the locations of other tracking units that will require inter-beam hand-offs, and, possibly, (4) a planned route and destination for each vehicle. The hub can make use of this information to determine the timing for hand-offs and the new beam, frequency, and slot assignments.

The alternative to inter-beam hand-off is simply to allow a tracking unit to briefly lose contact with the SATCOM network control terminal when it leaves a beam coverage area. The tracking unit must then log into the SATCOM system again on the sub-band corresponding to the beam that covers its existing position. In addition to the disadvantage of allowing the temporary loss of communication with an asset, this approach has the cost of requiring the channel structure and protocol to support more frequent tracking unit logins.

While only certain preferred features of the invention have been illustrated and described, many modifications and changes will occur to those skilled in the art. It is, therefore, to be understood that the appended claims are intended to cover all such modifications and changes as fall within the true spirit of the invention.

Having thus described our invention, what we claim as new and desire to secure by Letters Patent is as follows:

1. A two-way satellite communication system for communicating telemetry data, network parameters and control information, and commands between a network control terminal (NCT) and a plurality of tracking units, comprising:
at least one frequency division multiple access/time division multiplexed (FDMA/TDM) outbound carrier signal having scheduled slots, broadcast/group message slots, and response/acknowledgment slots;
at least one hybrid frequency division multiple access/time division multiple access (FDMA/TDMA) inbound channel having scheduled slots and random access slots, each inbound channel being associated with a respective outbound carrier signal;
a transmitter at the NCT for transmitting outbound signals to said plurality of tracking units;
a receiver at the NCT for receiving inbound signals from the tracking units;
a transmitter at each of the tracking units for transmitting signals on the shared FDMA/TDMA inbound channels to the NCT; and
a receiver at each of the tracking units for receiving FDMA/TDM outbound signals from the NCT,
the outbound carrier signals having
(i) scheduled time slots dedicated for transmission from the NCT to assigned tracking units,
(ii) broadcast/group message slots for transmission from the NCT to at least a designated group of tracking units, network parameters and control information and commands, and
(iii) response/acknowledgment time slots for transmission, from the NCT to tracking units, of responses to and acknowledgments of messages received on inbound channel random access slots; and
each inbound channel having
(i) scheduled time slots assigned to tracking units by the NCT and
(ii) random access time slots for use by any tracking unit assigned to said each inbound channel and by tracking units logging into the satellite communication system using a slotted ALOHA random channel access method.

2. The two-way satellite communication system recited in claim 1 wherein the slots of each outbound carrier signal and the slots of each inbound channel are organized into periodically occurring frames such that each of said tracking units is allocated at least one scheduled slot per frame on the outbound carrier signal and inbound channels to which the tracking unit is assigned, a frame interval being less than or equal to a maximum interval between telemetry data transmissions, and an interval between inbound random access (RA) slots being less than a desired delay in exception event reporting by the tracking units.

3. The two-way satellite communication system recited in claim 2 wherein each inbound scheduled time slot is logically associated with a corresponding outbound carrier signal scheduled time slot.

4. The two-way satellite communication system recited in claim 3 wherein each of said inbound-channel RA time slots is associated with a respective response/acknowledge (R/A) time slot in an outbound carrier signal.

5. The two-way satellite communication system recited in claim 1 wherein each of said tracking units is adapted to transmit a login request on a randomly selected random access slot after receiving a broadcast slot and said NCT is adapted to transmit an acknowledgment message on an acknowledgment slot corresponding to the randomly selected random access slot on which the login request was transmitted.

6. The two-way satellite communication system recited in claim 1 further comprising, at each of the plurality of tracking units, means for periodic reporting of telemetry data to the NCT by a protocol that involves first receiving a message from the NCT in a scheduled slot assigned to said each tracking unit, on an outbound carrier signal, and then transmitting telemetry data and control information in the inbound-channel scheduled slot assigned to said each tracking unit.

7. The two-way satellite communication system recited in claim 1 wherein each of the plurality of tracking units includes power conservation means for causing the respective tracking units to enter power conservation mode when said respective tracking units are not scheduled to receive broadcast/group time slots and assigned scheduled time slots on an outbound carrier signal and when said respective tracking units are not scheduled to transmit data during said assigned scheduled time slots on an inbound channel, each of the plurality of tracking units being adapted to power up to receive transmissions on an outbound carrier signal from the NCT during broadcast/group (B/G) and assigned scheduled time slots and to transmit on an inbound channel to the NCT during the assigned scheduled time slots for said each of the tracking units.

8. The two-way satellite communication system recited in claim 7 wherein the power conservation means is further adapted to cause the respective tracking units to power up to transmit on an inbound channel random access (RA) slot and to listen for a response or acknowledgement from the NCT during a response/acknowledgement (R/A) slot paired with said (RA) slot.

9. The two-way satellite communication system recited in claim 1 wherein the NCT is adapted to utilize a broadcast/group B/G slot to issue a command to one of the plurality of tracking units and assign a random access (RA) slot in which the commanded tracking unit is to respond to the command.

10. The two-way satellite communication system recited in claim 1 wherein the tracking units are grouped in wireless local area networks (LANs), each of said LANs including a respective master tracking unit for communicating with the NCT on behalf of all other tracking units in said each LAN.

11. The two-way satellite communication system recited in claim 10 wherein said respective master tracking unit in each of said LANs is adapted to transmit the telemetry data and control information of subordinate tracking units in a scheduled inbound link slot using the scheduled slots assigned to the subordinate tracking units in said LAN, said control information including LAN membership status and occurrence of high priority events.

12. The two-way satellite communication system of claim 1, further comprising a satellite including a multiple-beam transponder wherein, if a tracking unit begins to leave the area of coverage by a beam from the satellite and enters a region where at least two satellite beams overlap, the tracking unit is handed off to a satellite beam that can continue to provide coverage for the tracking unit, said tracking unit being adapted to assist the NCT in the handoff by finding a stronger outbound carrier signal from another beam upon detecting that power received from its assigned outbound carrier has dropped below a threshold.

13. The two-way satellite communication system of claim 1, further comprising a satellite including a multiple-beam transponder wherein, if a tracking unit begins to leave the area of coverage by a beam from the satellite, the NCT provides hand-off assignments from said beam to another beam based on information obtained from one of the group consisting of position history, a map of vehicle routes, locations of other tracking units that may require inter-beam hand-offs, a planned route for said subordinate tracking unit, and a destination for said subordinate tracking unit.

14. A method of forming wireless local area networks (LANs) of asset tracking units in a satellite communications system, wherein said system includes a network control terminal (NCT), comprising the steps of:
providing notification from said NCT to a tracking unit via an outbound channel transmission that said tracking unit is to act as a master tracking unit for a terrestrial wireless LAN;
providing acknowledgement by the appointed master tracking unit to said NCT that said notification has been received;
providing notification from said NCT to the appointed LAN master tracking unit of identification numbers of prospective network member subordinate tracking units;
providing notification from said NCT to the prospective local area network member subordinate tracking units of the identification number of the appointed LAN master tracking unit;
initiating communication between the LAN network master tracking unit and subordinate tracking units via terrestrial wireless LAN protocol to assimilate the subordinate tracking units into the LAN; and
providing the outcome of the subordinate tracking unit entry attempts from the master tracking unit to the NCT.

15. The method of forming wireless LANs of claim 14 wherein, if a subordinate tracking unit loses contact with its LAN, the LAN master tracking unit omits the identification number of said subordinate tracking unit from identification numbers provided to the NCT and terminates any use of the inbound link scheduled time slot assigned to said subordinate tracking unit so that said subordinate tracking unit can use its assigned scheduled time slot to transmit directly to the NCT.

16. The method of forming wireless LANs of claim 14 wherein, if a subordinate tracking unit loses contact with its LAN, the subordinate tracking unit continues to communicate with the NCT via its assigned link time slot until the NCT assigns said subordinate tracking unit to a new LAN.

17. In a method of tracking mobile assets which comprises affixing a tracking unit to each asset to be tracked, communicating with each tracking unit from a central station to receive from each tracking unit an identification number and location, storing and maintaining a table at the central station, said table including the identification number and location of each tracking unit, sorting tracking units in the table by location to identify tracking units within groups proximate to one another, the improvement of a multiple access technique and a two-way protocol between the central station and the tracking units comprising the steps of:
designating scheduled and random access slots in a return link transmitted from the tracking units to the central station;
designating scheduled, broadcast and acknowledgment slots in a forward link transmitted from the central station to the tracking units, the acknowledgment slots associated with the random access slots;
transmitting, by a tracking unit, a login request on a randomly selected random access slot after receiving a broadcast slot;
transmitting, by the central station, an acknowledgment message on an acknowledgment slot corresponding to the randomly selected random access slot on which the login request was transmitted, the acknowledgment including a channel and slot assignment;
tuning, by the tracking unit, to a frequency corresponding to the channel assignment of the acknowledgment;
executing a handshake procedure between the tracking unit and the central station; and
thereafter periodically conducting two-way communication between the tracking unit and the central station over the assigned channel.

18. The method recited in claim 17 wherein a communications link between the tracking units and the central station includes at least one satellite providing a communications beam directed onto a specific terrestrial area.

19. The method recited in claim 17 including a slow associated control channel for communicating overhead bits dedicated to control signaling in the slots of the forward and return links.

20. The method recited in claim 17 including a fast associated control channel for communicating in an entire traffic slot a high priority, long control message in lieu of regularly scheduled position information.

21. The method recited in claim 18 wherein, when a mobile asset begins to leave said specific terrestrial area and enters a region where said beam provided by said at least one satellite overlaps with a communications beam provided by another satellite, hand-off of said mobile asset from said at least one satellite to said another satellite is controlled, at least in part, by a forward link broadcast slot signal and a return link random access slot signal.

22. The method recited in claim 21 wherein said hands-off is based upon one or more of the group consisting of position data, a map of vehicle routes, locations of other tracking units that may require inter-beam hand-offs, a planned route for each asset, and a planned destination for each asset.

23. In a method of tracking mobile assets which comprises affixing a tracking unit to each asset to be tracked, communicating with each tracking unit from a central station to receive from each tracking unit an identification number and location, storing and maintaining a table at the central station, said table including the identification number and location of each tracking unit, sorting tracking units in the table by location to identify tracking units within groups proximate to one another, the improvement comprising the steps of:
designating scheduled and random access slots in a return link transmitted from the tracking units to the central station;
designating scheduled, broadcast and acknowledgment slots in a forward link transmitted from the central station to the tracking units, the acknowledgment slots associated with the random access slots;
transmitting, by the central station, messages to a plurality of selected tracking units in said LAN, simultaneously, via a forward link broadcast slot using a group address;
transmitting, by one of said selected tracking units, a login request on a randomly selected random access slot after said braodcast slot;
transmitting, by the central station, an acknowledgment on an acknowledgment slot corresponding to the randomly selected random access slot on which the login request was transmitted, the acknowledgment including a channel and slot assignment;
tuning, by the tracking unit, to a frequency corresponding to the channel assignment of the acknowledgment;
executing a handshake procedure between said one of said tracking units and the central station; and
thereafter periodically conducting two-way communication between said one of said tracking units and the central station over the assigned channel.

24. The method recited in claim 23 wherein said plurality of selected tracking units addressed simultaneously are addressed by location, which constitutes a specified region.
